(19) United States
(12) Patent Application Publication
(10) Pub. No.: US 2018/0310585 A1
(43) Pub. Date: Nov. 1, 2018

(54) NON-DAIRY CREAM FOR BAKING AND PREPARATION METHOD THEREOF

(71) Applicant: SHANGHAI HI-ROAD FOOD TECHNOLOGY CO., LTD., Shanghai (CN)

(72) Inventor: Haihu HUANG, Shanghai (CN)

(73) Assignee: SHANGHAI HI-ROAD FOOD TECHNOLOGY CO., LTD., Shanghai (CN)

(21) Appl. No.: 15/772,063

(22) PCT Filed: Oct. 28, 2016
(86) PCT No.: PCT/CN2016/103837

§ 371 Date: Apr. 29, 2018

(30) Foreign Application Priority Data
Oct. 28, 2015 (CN) 201510713141.2

(51) Int. Cl. A23D 7/04; A23L 9/20

(52) U.S. Cl. CPC A23D 7/04; A23L 9/22; A23V 2002/00; A23V 2250/1842; A23V 2250/5108; A23V 2300/20; A23V 2250/5026; A23V 2250/61; A23V 2250/606; A23V 2300/24; A23V 2300/26; A23V 2250/54246

(57) ABSTRACT

A non-dairy cream for baking includes the following raw materials in percentages by weight: 28-40% of plant fats, 0.02-0.5% of lecithin, 0.02-2% of salt, 0.02-0.5% of diacetyl tartaric acid mono-(di-)glycerides, 0.05-0.1% of mono- and di-glycerol fatty acid esters, 0-0.2% of sucrose fatty acid esters, 0-0.5% of polyglycerol esters, 2-5% of sweet whey powder, 0.05-1% of denatured cellulose, 0.1-2.5% of sodium caseinate, 0-0.5% of sodium stearyl lactylate, 0-0.5% of lactic acid glycerin fatty acid ester, 0-0.3% of sodium alginate, 0.002-0.2% of sodium iso-ascorbate, 3-6% of sugar, 3-6% of glucose syrup and 10-18% of high fructose corn syrup, the balance being water.

### TECHNICAL FIELD

The present invention relates to the technical field of cream products, particularly to non-dairy cream for baked products and preparation methods thereof.

### BACKGROUND ART

The object of the present invention is to provide a product/material of non-dairy cream for use in decoration of bakery goods. The non-dairy cream may be used as a dessert decorative material, as a cream product for beverage ingredients, or as a cream product for cooking. The cream products of the present invention are used for baked products, such as cream products as ingredients for breads or cakes. Conventional bread production is to add water (or ice water), oil, sugar, salt, yeast, dairy products, and other modifiers to flour, and beat the dough, loosen the dough in a mold, allow the dough to rise, and finish with baking.

The existing production methods have the following shortcomings: 1, there are many ingredients in the existing bread and cake process, with many operation steps that easily cause product inconsistency; 2, there are many ingredients in the existing bread and cake making, which is complicated to manage, and the shelf lives of different ingredients are different, and therefore some ingredients will be wasted; 3, for the amounts of ingredients, bakers need to check them on the spot according to the formula, thereby the work efficiency is low and it is easy to have errors.

### SUMMARY OF THE INVENTION

The present invention is to provide non-dairy butter/cream and preparation methods thereof, to solve the foregoing problems in the prior art.

An object of the present invention is achieved through the following technical solutions.

A non-dairy cream for baking or bakery, comprising the following components (raw materials) in weight percents:
Vegetable oil/fat 28%-40%,
Lecithin 0.02%-0.5%,
Salt 0.02%-2%,
DATEM (diacetyl tartaric acid ester of mono- and diglycerides, also known as E472e) 0.02%-0.5%,
Mono and di-glycerin fatty acid esters 0.05%-1%,
Sucrose fatty acid esters 0-0.2%,
Polyglycerol ester 0-0.5%,
Sweet whey powder 2%-5%,
Denatured cellulose 0.05%-1%,
Sodium caseinate 0.1%-2.5%,
Sodium stearoyl lactylate 0-0.5%,
Lactic and fatty acid esters of glycerol 0-0.5%,
Sodium alginate 0-0.3%
Sodium iso-ascorbate (sodium erythorbate) 0.002%-0.2%,
Sugar 3%-6%,
Glucose syrup 3%-6%,
Fructose syrup 10%-18%, and
Water, making up the remaining wt %,
wherein the vegetable oil/fat is one of palm oil, soybean oil, hydrogenated soybean oil, hydrogenated palm kernel oil, and non-hydrogenated palm kernel oil.

A method for preparing a non-dairy cream for baking, comprising the following steps:

1) Melt/heat vegetable fat/oil to 60-65° C., add lecithin, DATEM, mono and diglycerin fatty acid esters, sucrose fatty acid esters, polyglycerol ester, denatured cellulose and sodium caseinate, iso-ascorbic acid, sweet whey powder, salt, and stir to disperse the ingredients evenly to obtain an oil phase mixture A;

2) Dissolve the sugar, glucose syrup and fructose syrup in 60-70° C. water to obtain an aqueous phase solution B;

3) Pour the aqueous phase solution B into the oil phase mixture A, mix well and pasteurize;

4) then homogenize the mixture and stir for one hour at a temperature below 10° C.;

5) Perform filling, and store under a frozen condition below −18° C.

For the foregoing method, the homogenizing is performed at 30-60 MPa and the frequency of homogenization is 1-2 times.

The pasteurizing is by heating at 63-70° C. for 25-45 minutes.

The present invention has the following beneficial effects:
1. this product can be used to make bread with water, flour, yeast, or part of the oil, eggs, flour and baking powder and the cream can be used to produce cakes, which simplifies the operating steps and improves the efficiency, avoids the influence of human experiences and increases the yield of finished products;
2. since the product is frozen, ice water is not required when the temperature is high;
3. the product quality is not decreased, instead, with the synergistic effect of the emulsifier, the product texture is more uniform and breads and cakes made are more delicious;
4. with the synergistic effect of denatured celluloses, sodium caseinate and stearyl lactylic acid, cakes can be cracked when baking the heavy oil cakes. In addition, it is not necessary to manually pull out the baking box, saving the baking time and reducing energy consumption.
5. the cakes made have faster oil return, improving the efficiency, and the moisture retention and wetting effect, prolonging the shelf life.

### DETAILED DESCRIPTIONS OF THE INVENTION

The present invention is further described in combination with specific examples/embodiments.

### Example 1

Take hydrogenated palm kernel oil 362 g, salt 10 g, sodium iso-ascorbate 0.2 g, DATEM 3 g, sodium stearoyl lactylate 2.7 g, mono and diglycerin fatty acid esters 2 g, sucrose fatty acid esters 1.2 g, lecithin 3 g, polyglycerol ester 1.0 g, denatured cellulose 7.0 g, sodium caseinate 7.5 g, sweet whey powder 30 g, sugar 30 g, fructose syrup 107 g, glucose syrup 45 g and water 386.6 g.

### Preparation Process

Melt hydrogenated palm kernel oil and heat to 60° C., add lecithin, DATEM, sodium stearate, sodium stearoyl lactylate, mono and diglycerin fatty acid esters, sucrose fatty acid esters, polyglycerol ester, sodium iso-ascorbate, denatured cellulose, sodium caseinate, sweet whey powder, and salt. Stir and disperse them evenly to get an oil phase mixture. In addition, dissolve sugar, syrup and dairy fat-containing dairy products in 60° C. water, and add the aqueous phase to the oil phase. Dissolve the sugar and syrup in 60° C. water. Add the aqueous phase to the oil phase, stir evenly at a rate of 40 rpm and pasteurize, and then homogenize. Slowly stir for one hour below 10° C. (e.g., 0-10° C.), fill and freeze below −18° C. The homogenizing condition is 40 MPa and the frequency of homogenization is one time. The sterilization/pasteurization temperature is 63-70° C. and the time is 45 minutes.

The resulting product is stable and tastes well.

### Example 2

Take hydrogenated palm kernel oil 375 g, salt 15 g, sodium iso-ascorbate 1.7 g, DATEM 3 g, sodium stearoyl lactylate 2.6 g, mono and diglycerin fatty acid esters 2 g, sodium alginate 1.1 g, lecithin 4 g, lactate monoglyceride 1.3 g, denatured cellulose 9.3 g, sodium caseinate 2.5 g, sweet whey powder 30 g, sugar 35 g, fructose syrup 112 g, glucose syrup 45 g, water 360.2 g.

Melt hydrogenated palm kernel oil and heat to 65° C., add lecithin, lactate monoglyceride, sodium stearoyl lactylate, mono and diglycerin fatty acid esters, DATEM, iso-ascorbic acid, sodium stearoyl lactylate, sodium alginate, sweet whey powder, denatured cellulose and sodium caseinate. Stir and disperse them evenly to get an oil phase mixture. In addition, dissolve sugar, syrup in 70° C. water, and add the aqueous phase to the oil phase. Dissolve the sugar and syrup in 70° C. water. Add the aqueous phase to the oil phase, stir evenly at a rate of 70 rpm and pasteurize, and then homogenize. Slowly stir for one hour below 10° C., fill and freeze below −18° C. The homogenizing condition is 40 MPa and the frequency of homogenization is two times. The sterilization temperature is 70° C. and the time is 25 minutes.

The resulting product is stable and tastes well.

### Example 3

Take lecithin 25 g, salt 100 g, DATEM 25 g, mono and diglycerin fatty acid esters 50 g, sucrose fatty acid esters 10 g, polyglycerol ester 20 g, sweet whey powder 300 g, denatured cellulose 50 g, sodium caseinate 100 g, sodium stearoyl lactylate 30 g, lactic and fatty acid esters of glycero 130 g, sodium alginate 20 g, sodium isothionate 10 g, sugar 400 g, glucose syrup 400 g, fructose syrup 1500 g; add appropriate amount of water.

Heat the soybean oil to 65° C., add lecithin, DATEM, mono and diglycerin fatty acid esters, sucrose fatty acid esters, polyglycerol ester, denatured cellulose and sodium caseinate, iso-ascorbic acid, sweet whey powder, salt. Stir and disperse them evenly to get oil phase mixture A; dissolve the sugar, glucose syrup and fructose syrup in 70° C. water to get the aqueous phase solution B; add the aqueous phase solution B to the oil phase mixture A, stir evenly and pasteurize at 65° C. for 35 minutes; and then homogenize twice at 50 Mpa; stir one hour below 10° C., fill and freeze below −18° C.

The resulting product is stable and tastes well.

### Example 4

Take soybean oil 4000 g, lecithin 50 g, salt 200 g, DATEM 50 g, mono and diglycerin fatty acid esters 100 g, sucrose fatty acid esters 20 g, polyglycerol ester 40 g, sweet whey powder 400 g, denatured cellulose 100 g, sodium caseinate 150 g, sodium stearoyl lactylate 50 g, lactic and fatty acid esters of glycero 140 g, sodium alginate 30 g, sodium isothionate 10 g, sugar 500 g, glucose syrup 600 g, fructose syrup 1600 g; add appropriate amount of water.

Heat the soybean oil to 65° C., add lecithin, DATEM, mono and diglycerin fatty acid esters, sucrose fatty acid esters, polyglycerol ester, denatured cellulose and sodium caseinate, iso-ascorbic acid, sweet whey powder and salt. Stir and disperse them evenly to get oil phase mixture A; dissolve the sugar, glucose syrup and fructose syrup in 70° C. water to get the aqueous phase solution B; add the aqueous phase solution B to the oil phase mixture A, stir evenly and pasteurize at 65° C. for 45 minutes; and then homogenize twice at 60 Mpa; stir one hour below 10° C., fill and freeze below −18° C.

The resulting product is stable and tastes well.

### Example 5: Making Sliced Bread and Heavy Oil Cakes with Baked Creams

Raw materials formula (g): A. sponge dough, high-gluten flour: 80, yeast: 8; water: 50 B. Dough stage, high-gluten flour: 20, whole egg: 150, baked cream obtained in Example 2: 410.

Bread Making: neutralizing the dough. Stir the high-gluten flour, yeast and water at low speed for 5 minutes and then stir at high speed for 1 minute. Ferment the dough in a fermenting box (temperature 35° C., humidity 80%) for 90 minutes.

Place the fermented sponge dough in a stirring tank, then add the high-gluten flour, whole egg and half of the baked cream obtained in Example 2 according to the ingredients of dough stage, stir for 12 minutes at low speed, then add another half of baked cream obtained in Example 2, stir for 12 minutes at low speed, finally stir at high speed for 1 minute until the gluten is fully expanded. After relaxation for 60 minutes, divide them into 200 g of dough and place to a mould, and then place to a fermenting box (temperature 35° C., humidity 80%) for fermentation until 80% of fermentation, put into a baking oven (fire temperature at the upper and lower parts: 200° C., for 40 minutes). Then the finished breads can come out of the oven.

The moisture content of the baked cake is more than 20%. The water content of the traditional cake is 15-16%, thus prolonging the shelf life. In addition, cracks are naturally formed during baking of heavy oil cakes. For the traditional heavy oil cakes, it is required to pull the cakes out of the oven during the baking process and manually cut them, which will prolong the baking time and increase energy consumption. The whole mixing process lasts 24 minutes, while the traditional ways will take 40 to 60 minutes. Therefore, it greatly reduces the mixing time and improves the working efficiency.

### Example 6: Making Plain Butter Cakes

Raw material formula (grams): 600 g of baked cream obtained in Example 3, 300 g of granulated sugar, 500 g of whole egg, 200 g of butter, 450 g of low-gluten flour, and 300 g of baking powder.

Slowly stir the baked cream obtained in Example 3, add granulated sugar to stir until dissolved. Add the whole egg in several times and stir evenly, then add butter to stir evenly, finally add the sieved low gluten flour and baking powder to stir uniformly. Divide the pastes into molds and place in an oven (fire temperature at the upper and lower parts: 180° C., for 15 minutes) until the surface is colored, then the surface is cut with a knife. Decrease the fire temperature of the oven to 160° C., then bake 20 to 25 minutes. Then the finished breads can come out of the oven.

The oil can be returned on the second day after the production of cakes, with high gloss. The oil return of traditional process needs more than 30 hours; moreover, the oil content of traditional cream is high. The present invention has low oil content, reducing the oil intake without affecting the taste.

The above process reduces the defective rate caused by human factors during the whole baking process, and lowers the production and management costs.

The above making process is easy and convenient compared with the existing process, with low costs and low quality of finished products. The present invention is a new raw material for the production of breads and cakes, suitable for mass production and application in bakeries.

What is claimed is:

1. A non-dairy cream for baking, comprising following components in weight percent:
vegetable fat 28%-40%;
lecithin 0.02%-0.5%;
salt 0.02%-2%;
DATEM (diacetyl tartaric acid ester of mono- and diglycerides) 0.02%-0.5%;
mono and di-glycerin fatty acid esters 0.05%-1%;
sucrose fatty acid esters 0-0.2%;
polyglycerol ester 0-0.5%;
sweet whey powder 2%-5%;
denatured cellulose 0.05%-1%;
sodium caseinate 0.1%-2.5%;
sodium stearoyl lactylate 0-0.5%;
lactic and fatty acid esters of glycerol 0-0.5%;
sodium alginate 0-0.3%;
sodium iso-ascorbate 0.002%-0.2%;
sugar 3%-6%;
glucose syrup 3%-6%;
fructose syrup 10%-18%; and
water, accounting for remaining weight percent.

2. The non-dairy cream according to claim 1, wherein the vegetable fat is one selected from the group consisting of palm oil, soybean oil, hydrogenated soybean oil, hydrogenated palm kernel oil, and non-hydrogenated palm kernel oil.

3. A method for preparing the non-dairy cream according to claim 1, comprising:
1) melting or heating the vegetable fat to 60-65° C., adding the lecithin, the DATEM, the mono and diglycerin fatty acid esters, the sucrose fatty acid esters, the polyglycerol ester, the denatured cellulose, the sodium caseinate, the sodium iso-ascorbate, the sweet whey powder, and the salt, and stirring to disperse ingredients evenly, to obtain an oil phase mixture A;
2) dissolving the sugar, the glucose syrup, and the fructose syrup in 60-70° C. water to obtain an aqueous phase solution B;
3) pouring the aqueous phase solution B into the oil phase mixture A to obtain a combined mixture, followed by mixing and pasteurizing the combined mixture;
4) homogenizing the combined mixture and stirring for one hour below 10° C.; and
5) performing filling and storing under a freezing condition at a temperature below −18° C.

4. The method according to claim 3, wherein the homogenizing is performed at 30-60 MPa and the homogenizing is performed 1-2 times.

5. The method according to claim 3, wherein the pasteurizing is by heating at 63-70° C. for 25-45 minutes.
